(19) United States
(12) Patent Application Publication
(10) Pub. No.: US 2017/0239754 A1
(43) Pub. Date: Aug. 24, 2017

(54) SYSTEM AND METHOD OF LASER MARKING PRODUCE

(71) Applicant: IPG PHOTONICS CORPORATION, Oxford, MA (US)

(72) Inventor: Anthony HOULT, Oxford, MA (US)

(21) Appl. No.: 15/518,907

(22) PCT Filed: Oct. 22, 2015
(86) PCT No.: PCT/US2015/056808

§ 371 Date: Apr. 13, 2017

Related U.S. Application Data
(60) Provisional application No. 62/067,249, filed on Oct. 22, 2014.

(51) Int. Cl. B23K 26/352; G06K 19/06; G06K 1/12; B23K 26/00

(52) U.S. Cl. CPC B23K 26/352; B23K 26/0084; G06K 19/06037; G06K 19/06121; G06K 1/121; B23K 2203/30

(57) ABSTRACT

The present invention provides systems and methods for laser marking of produce with a laser beam with a center wavelength in the mid-infra-red region without the need for additional surface agents or chemicals to enhance the marking. The present invention further provides produce marked by a laser beam with a center wavelength in the mid-infra-red regions that is free of any additional surface agents or chemicals.

### BACKGROUND OF THE DISCLOSURE

Field of the Disclosure

The disclosure relates to systems and methods for permanently marking an exterior surface of produce with a laser beam in the mid-IR spectral region with a power and process time to alter the surface of such produce without the need for additional surface agents or chemicals.

Background of the Disclosure

On 23 Jun. 2013, a law in the European Union came into force that allowed the use of iron oxides, hydroxides, hydroxypropyl methyl cellulose and polysorbates for the laser marking of citrus fruit, melons and pomegranates. These chemicals were required because the carbon dioxide laser used to mark the fruit did not produce a wavelength of light suitable to be absorbed by the fruit and visible to the fruit purchaser.

While most, but not all of the above chemicals are non-toxic to humans, it is manifest that direct marking of fruit without the need for any surface agents or additives would be the most attractive economic and environmentally-safe alternative.

The attractions of eliminating the use of “sticky” labels on fruit are abudently clear. Substantial expense in both equipment and label stock are required to adequately label produce. Label stock is an expense that requires space and procurement resources that can be quite burdensome in the produce industry, a commodity industry with notoriously tight margins.

In addition, the use of laser marking coupled with software in laser systems can allow for greater precision in tracking the origin of fruit. Indeed, labeling in the field or immediately after a first washing would facilitate traceability of all produce.

A need exists for a system and method of laser marking produce without the need for additional surface agents or chemicals that provide a robust mark that can last until the produce is consumed or rots beyond its useful life.

### SUMMARY OF THE DISCLOSURE

The present invention provides a laser system for laser marking produce without the need for additional surface agents or chemicals. In a preferred embodiment of the invention, the laser beams used for the marking has a center wavelength in the mid-infra-red region. More preferably, the laser beam has a center wavelength in the range from 1900 to 2100 nm.

In a most preferred system and method of practicing the present invention, a laser beam produced by a thulium fiber laser is used to scribe the produce.

The present invention further provides methods for laser marking produce, the method including selecting a laser beam in the mid-infra-red spectrum suitable to be absorbed by the skin of produce or the surface of a produce free of a skin; preselecting a graphic or word to be marked or scribed on the surface of the produce; and exposing the produce to the laser beam for a time and power sufficient to permanently mark or scribe the pre-selected graphic or word on the produce. The method further characterized in that there is no need for any additional agent or chemical, either on the surface or otherwise, to enhance the pre-selected graphic.

The present invention further provides produce produced by the methods disclosed herein. In particular, produce having a pre-selected graphic and free from additional surface agents or chemicals needed to enhance the pre-selected graphic. Such produce of the present invention would be prepared by a process including the steps of providing a laser module capable of producing a laser beam with a center wavelength in the mid-infra-red region; providing a beam delivery system configured to deliver the laser beam to the external surface of the produce; selecting a laser beam in said mid-infra-red region suitable to be absorbed by the external surface of the produce; and exposing produce free of any additional surface agents or chemicals to the laser beam for a time, power and in a pattern sufficient to permanently mark the produce with the pre-selected graphic.

### BRIEF DESCRIPTION OF THE DRAWINGS

The above and other aspects, features and advantages of the disclosure will become more readily apparent with the aid of the following drawings, in which:

FIG. 1 is a photograph of a laser marking on an apple using the present invention.

FIG. 2 is a photograph of standard sized apple.

FIG. 3 is a photograph of a laser marking on a banana using the present invention.

FIG. 4 is a photograph of a standard-sized banana.

### SPECIFIC DESCRIPTION

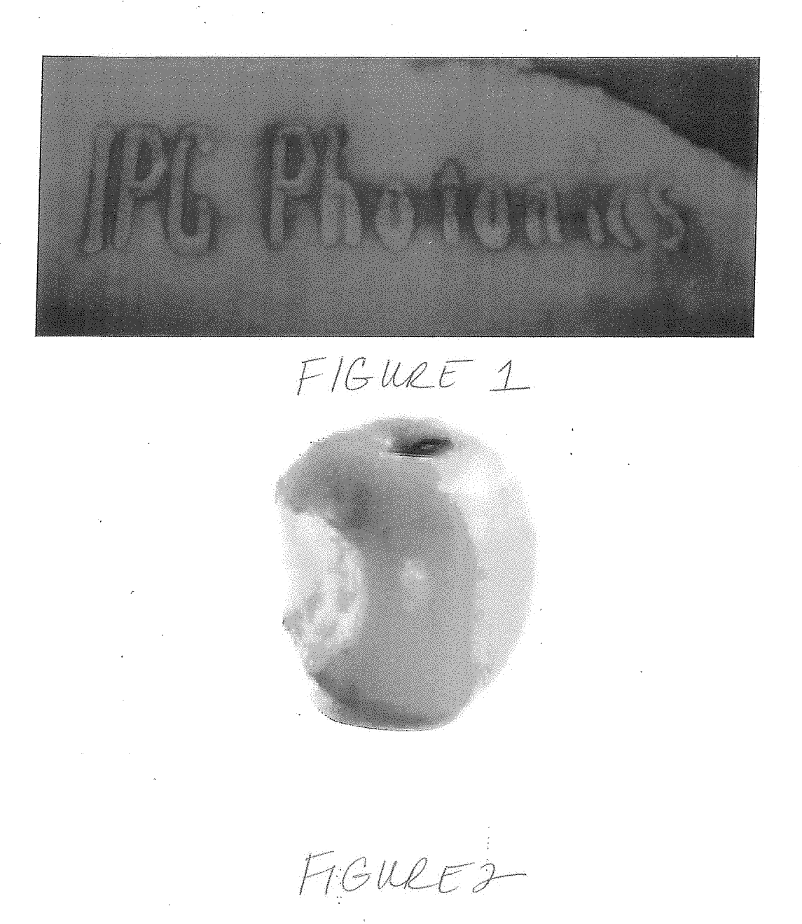

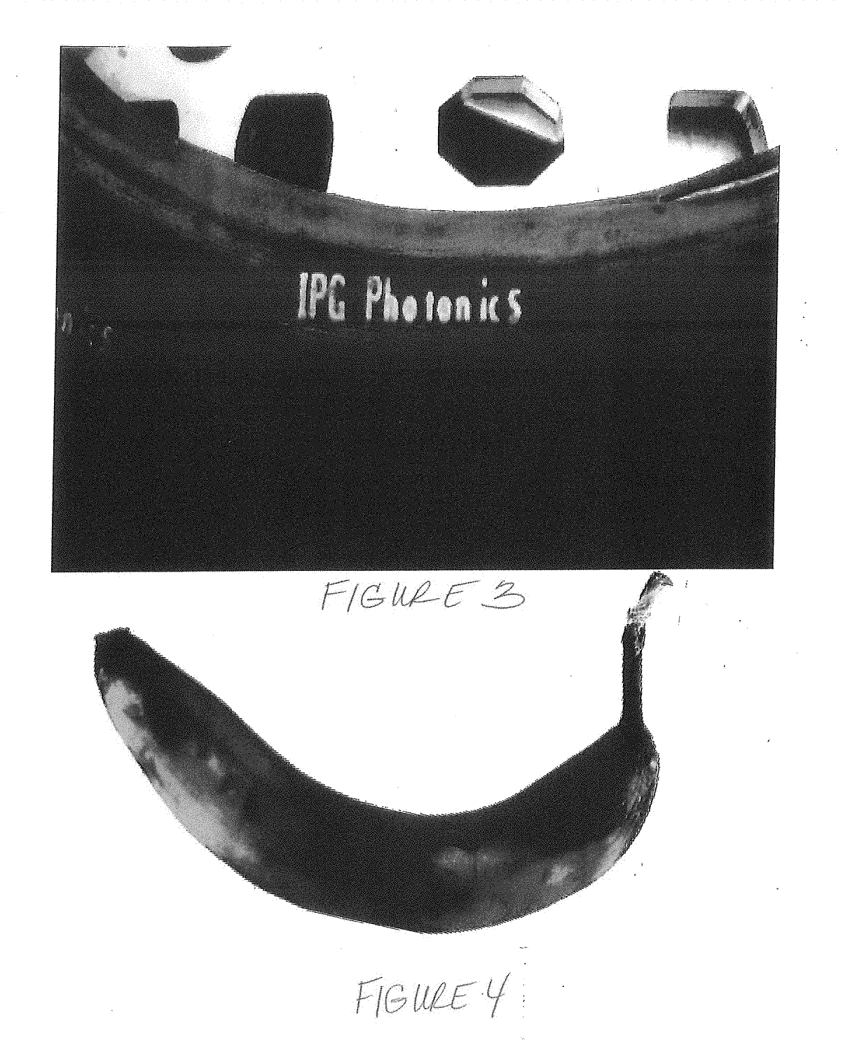

Reference will now be made in detail to embodiments of the invention. Wherever possible, same or similar reference numerals are used in the drawings and the description to refer to the same or like parts or steps. The drawings in this application are photographs. The heights of the markings in FIGS. 1 and 3 are representative of the capabilities of the present invention are not limiting thereof. In addition, even though only words were inscribed in the samples, it follows that the present invention may include drawings of all sorts. For purposes of convenience and clarity only, directional (up/down, etc.) or motional (forward/back, etc.) terms may be used with respect to the drawings. The tem “couple” and similar terms do not necessarily denote direct and immediate connections, but also include connections through intermediate elements or devices.

FIG. 1 sets forth one end product of the use of the present invention ten days after it was marked. Specifically, the figure provides an apple marked with a laser system of the present invention. Specifically, a TLM-120 fiber laser manufactured by IPG Photonics Corporation was tuned to a 30 W output. The laser was set to continuous wave operation. Set to a marking speed of 50 mm/s, the laser beam was pre-programmed to mark the phrase “IPG Photonics” in a Helvetica font with a pitch of 9 on the surface of the apple.

As FIG. 2 provides a standard sized apple, it follows that the present invention provides an opportunity to mark fruit with logos, graphics, text and mixtures thereof. Indeed, it is contemplated that the present invention may be used to affix quick response codes (QRC) and universal product codes (UPC) or other similar codes to provide information regarding the produce, such as location, date picked, vendor and pricing.

FIG. 3 provides another end product of the use of the present invention one month after it was marked. Specifically, the figure provides a banana marked with a laser system of the present invention. Specifically, a TLM-120 fiber laser manufactured by IPG Photonics Corporation was tuned to a 30 W output. The laser was set to continuous wave operation. Set to a marking speed of 50 mm/s, the laser beam was pre-programmed to mark the phrase “IPG Photonics” in a Helvetica font with a pitch of 9 on the surface of the banana.

Much like FIG. 2, FIG. 4 is a photograph of a standard sized banana and is provided so one of ordinary skill in the art could appreciate the graphical detail that present invention may produce. Indeed, those of ordinary skill in the art would recognize that font and pitch selection would be limited only by the imagination and the surface area of selected produce.

While not apparent from the photograph, on close inspection of the banana, it was clear that the skin portion exposed to the laser beam from the thulium fiber laser had not rotted. Indeed, the banana had rotted around the marked or scribed area. It appears that the method of the present invention seals the surface of the fruit to limit oxidation, thereby explaining why the marked portion did not rot.

Those skilled in the art will recognize or be able to ascertain using no more than routine experimentation many equivalents to the specific embodiments of the invention described herein. It is therefore to be understood that the foregoing embodiments are presented by way of example only and that within the scope of the appended claims and equivalents thereto, the invention may be practiced otherwise than as specifically described. The present disclosure is directed to each individual feature, system, material and/or method described herein. In addition, any combination of two or more such features, systems, materials and/or methods, if such features, systems, materials and/or methods are not mutually inconsistent, is included within the scope of the present invention.

1. A laser system for producing a laser beam sufficient to mark produce without the need for additional surface agents or chemicals, the system comprising:
a laser module capable of producing a laser beam with a center wavelength in the mid-infra-red region,
a beam delivery system configured to deliver the laser beam to the external surface of the produce;
control means for receiving a graphic input to be scribed onto the external surface of produce and for setting a scribing speed for scribing the graphic output on the produce; and
a substrate suitable for positioning the produce so it may be scribed.

2. The laser system of claim 1, wherein the laser module has a laser beam with a center wavelength in the range from 1900 to 2100 nm.

3. The laser system of claim 2, wherein the laser module is a fiber laser module, the active fiber therein substantially doped with Thulium.

4. The laser system of claim 1, wherein the laser module is configured to run in continuous wave operation.

5. A method of scribing produce with a laser beam free from the requirement of a surface agent or chemical to enhance the scribe, the method comprising:
Selecting a laser beam in the mid-infra-red spectrum suitable to be absorbed by the skin or surface of a produce free of a skin;
Preselecting a graphic or word to be scribed on the surface of the produce; and
Exposing the produce to the laser beam for a time and power sufficient to permanently scribe the pre-selected graphic or word on the produce, wherein the skin or surface of the produce is free of any additional agent or chemical needed to enhance the pre-selected graphic.

6. The method of claim 5, wherein the laser beam selected has a center wavelength in the range of 1900 to 2100 nm.

7. The method of claim 5, wherein the pre-selected graphic is a quick response code or a universal product code.

8. Produce having a pre-selected graphic that is free from additional surface agents or chemicals prepared by a process comprising the steps of:
providing a laser module capable of producing a laser beam with a center wavelength in the mid-infra-red region;
providing a beam delivery system configured to deliver the laser beam to the external surface of the produce;
selecting a laser beam in said mid-infra-red region suitable to be absorbed by the external surface of the produce; and
exposing produce free of any additional surface agents or chemicals to the laser beam for a time, power and in a pattern sufficient to permanently mark the produce with the pre-selected graphic.

9. The produce of claim 8, wherein the pre-selected graphic is a quick response code or a universal product code.
